(19) United States
(12) Patent Application Publication
(10) Pub. No.: US 2012/0030315 A1
(43) Pub. Date: Feb. 2, 2012

(54) Remote Transcription and Reporting System and Method

(76) Inventors: Reesa Parker, Dallas, TX (US); William E. Weber, Bethel Park, PA (US); Harvey Schulman, Atlanta, GA (US)

(21) Appl. No.: 13/190,671

(22) Filed: Jul. 26, 2011

Related U.S. Application Data
(60) Provisional application No. 61/368,840, filed on Jul. 29, 2010.

(51) Int. Cl. G06F 15/16

(52) U.S. Cl. 709/219

(57) ABSTRACT

A transcription and reporting system, including: at least one remote data capture device positioned in a specified location and configured or programmed to at least one of capture and process event data, and transmit at least a portion of the event data over at least one network; and at least one central data receiving interface configured or programmed to receive at least a portion of the event data transmitted by the at least one remote data capture device; wherein at least a portion of the event data is at least one of the following: testimony data, visual data, aural data, tactile data, chat data, environment data, location data, condition data, or any combination thereof. A transcription and reporting method and remote data capture device are also disclosed.

### CROSS REFERENCE TO RELATED APPLICATIONS

This application claims priority to U.S. Provisional Application No. 61/368,840 filed Jul. 29, 2010, which is herein incorporated by reference in its entirety.

### BACKGROUND OF THE INVENTION

1. Field of the Invention

The present invention relates generally to transcription and reporting systems and methods, such as those used in legal proceedings, court-based activities, meetings, and the like, and in particular to a remote transcription and reporting system and method that provides effective and real-time transcription and reporting methods and supportive activities and functions in a network environment.

2. Description of the Related Art

As is known in the art, in many different legal proceedings and court systems, an interactive event must be accurately and effectively recorded in order to establish the official record. Accordingly, a trained person must be present at the proceeding in order to capture the “live” testimony or local conditions for future editing, preservation, and presentation during these ongoing proceedings. This individual, e.g., the court reporter, attends the event with a laptop or other device that is used to transcribe the testimony and local conditions as they occur. Afterward, the court reporter returns to his or her office, and the raw transcript is edited, modified, corrected, and otherwise reviewed in order to develop the official document, i.e., the transcript. Often, one or more of the persons in attendance at the proceeding, will review the non-final transcript in order to make or suggest any additional modifications. Once this final review step or “read” occurs, the final transcript document is prepared and serves as the official document evidencing what was said and occurred at the legal proceeding.

These legal proceedings may include courtrooms, depositions, hearings, arbitrations, mediations, or any other venue or event that requires a visual or textual record. As such, a text record may be required at meetings and other events that are not considered a “legal” event. The present invention may also be used in connection with such non-legal events and proceedings, again in order to capture, deliver, and textually or visually preserve the words or conditions at the local event.

Since the present transcription and reporting methods are and have been used for decades, there remains ample room for improvements in the field of transcription and reporting. As is evident, any method that relies upon multiple humans throughout the process may lead to errors, inefficiencies, delays, and other issues. Accordingly, these existing transcription and reporting methods may be improved to yield increased efficiency and accuracy, cost effectiveness, improved timeliness, etc.

### SUMMARY OF THE INVENTION

It is, therefore, one object of the present invention to provide a remote transcription and reporting system and method that overcomes some or all of the drawbacks and deficiencies mentioned above in connection with existing methods. Preferably, the present invention provides a remote transcription and reporting system and method that improves or leads to increased efficiency and accuracy, cost effectiveness, and/or improved timeliness. Further, and preferably, the present invention provides a remote transcription and reporting system and method that provides remote transcription, reporting, and related services, and can be used to capture, deliver, and preserve testimony or conditions in real-time.

Accordingly, and in one preferred and non-limiting embodiment, provided is a transcription and reporting system. This system includes at least one remote data capture device positioned in a specified location and configured or programmed to at least one of capture and process event data, and transmit at least a portion of the event data over at least one network. Further, at least one central data receiving interface is configured or programmed to receive at least a portion of the event data transmitted by the at least one remote data capture device. At least a portion of the event data is at least one of the following: testimony data, visual data, aural data, tactile data, chat data, environment data, location data, condition data, or any combination thereof.

In a further preferred and non-limiting embodiment, provided is a remote data capture device positioned in a specific location. The device includes: (i) at least one component configured to capture raw data from the surrounding environment; (ii) at least one component configured to process the raw data; and (iii) at least one component configured to transmit at least a portion of the processed data over at least one network.

In another preferred and non-limiting embodiment, provided is a computerized transcription and reporting method. The method includes: (i) receiving, over a network, event data from a remote data capture device positioned in a specified location, wherein at least a portion of the event data is at least one of the following: testimony data, visual data, aural data, tactile data, chat data, environment data, location data, condition data, or any combination thereof; (ii) processing at least a portion of the received event data, thereby providing transcription data; and (iii) storing at least a portion of the following data: event data, processed data, transcription data, testimony data, visual data, aural data, tactile data, chat data, environment data, location data, condition data, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and, “the” include plural referents unless the context clearly dictates otherwise.

### BRIEF DESCRIPTION OF THE DRAWINGS

FIG. 1 is a schematic view of one embodiment of a remote transcription and reporting system and method according to the principles of the present invention;

FIG. 2 is a schematic view of another embodiment of a remote transcription and reporting system and method according to the principles of the present invention;

FIG. 3 is a schematic view of a further embodiment of a remote transcription and reporting system and method according to the principles of the present invention;

FIG. 4 is a schematic view of a still further embodiment of a remote transcription and reporting system and method according to the principles of the present invention; and

FIG. 5 is a schematic view of another embodiment of a remote transcription and reporting system and method according to the principles of the present invention.

### DETAILED DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. Further, it is to be understood that the invention may assume various alternative variations and step sequences, except where expressly specified to the contrary.

The present invention may be implemented on one or more computers, computing devices, or computing systems. Such computers should include the necessary hardware, components, internal and external devices, and/or software to implement one or more of the various steps and processes discussed hereinafter, including, but not limited to, data capture, processing, and communication in a network environment. Further, one or more of the computers of the computing system includes program instructions and/or particular, specialized programs to effectively implement one or more of the steps of the present invention. Still further, one or more of the modules or portions of these program instructions can be stored on or implemented using known articles and physical media.

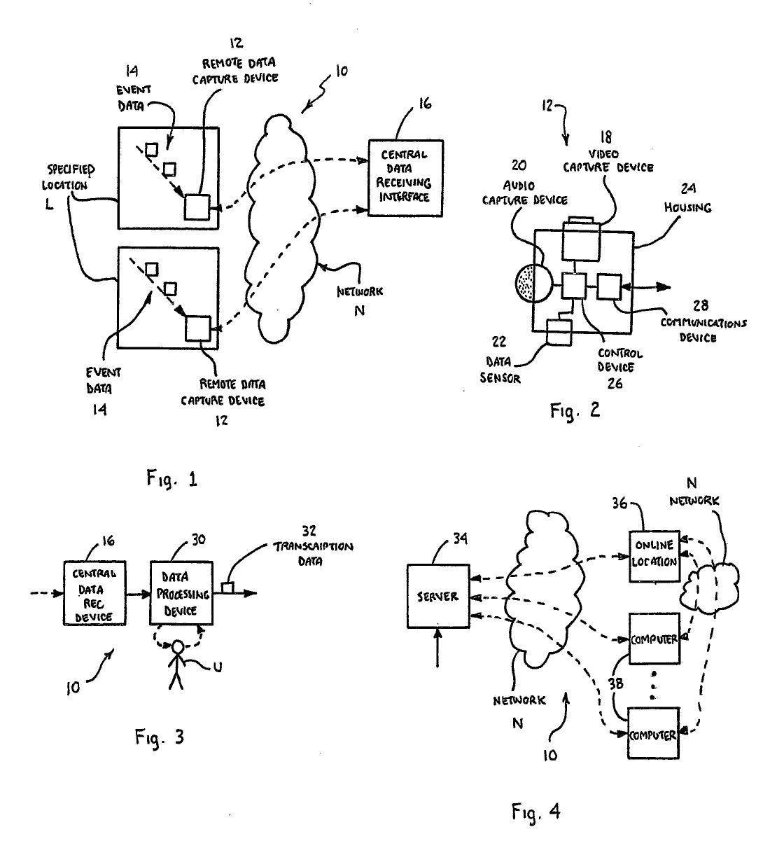

The present invention is directed to a remote transcription and reporting system 10 and method, as well as a remote data capture device 12, which are illustrated in various preferred and non-limiting embodiments and environments in FIGS. 1-6. In one preferred and non-limiting embodiment, and as illustrated in FIG. 1, the system 10 of the present invention includes at least one remote data capture device 12 positioned in a specified location L. This remote data capture device 12 is configured or programmed to capture and/or process event data 14, as well as transmit some or all of this event data 14 over a network N. Further, the system 10 includes at least one central data receiving interface 16 that is configured or programmed to receive some or all of this event data 14 transmitted by the remote data capture device 12 over the network N. The event data 14 may take many forms and data types, and is representative of a variety of local environmental conditions, such as testimony data, visual data, oral data, tactile data, chat data, environment data, location data, and/or condition data. In operation, the remote data capture device 12 includes the necessary components to obtain or capture data at the specified location L, such that this event data 14 can be processed and transmitted to the central data receiving interface 16. Additionally, it is envisioned that more than one remote data capture device 12 can be used simultaneously in respective specified location L, with the event data 14 from each specified location L transmitted to the same central data receiving interface 16.

As illustrated in FIG. 2, the remote data capture device 12 may take a variety of forms. For example, the remote data capture device 12 may be in the form of a computer or some computing device having the necessary components to capture the event data 14. Also, as illustrated in one preferred and non-limiting embodiment in FIG. 2, the remote data capture device 12 may be in the form of or include a video capture device 18, such as a video camera, a “snapshot” camera, or the like, which is used to acquire and capture visual data. In addition, the remote data capture device 12 may be in the form of or include an audio capture device 20, such as a microphone or the like, for obtaining audio or oral data. Still further, the remote data capture device 12 may be in the form of or include one or more data sensors 22 for capturing or determining tactile data, environment data, condition data, etc. As discussed above, this remote data capture device 12 may be a computing device or automated unit that integrates some or all of these features and functions, and may be configured or programmed to capture, process, and/or transmit any such data useful within the context of the present invention.

As further seen in the preferred and non-limiting embodiment of FIG. 2, the remote data capture device 12 is in the form of a portable unit that can be positioned in different locations L during and between uses. Accordingly, the remote data capture device 12 includes a housing 24, and within the housing 24, a control device 26 is used to control the various components for capturing the event data 14. In addition, this control device 26 controls a communications device 28 used to transmit the event data 14 to the central data receiving interface 16. Such transmission may occur in a wired or wireless architecture. Still further, it is envisioned that a remote user can communicate with the remote data capture device 12 to remotely control any one or more of the components of the device 12. For example, the remote user can adjust the pan, zoom, tilt of the video capture device 18, the level or directional input of the audio capture device 20, features and functions associated with the data sensor 22, etc. It is further envisioned that the remote data capture device 12 includes or is in communication with a local storage device for storing the event data 14 in raw, pre-processed, or processed form.

With further reference to the embodiment of FIG. 2, the remote data capture device 12 uses the video capture device 18, the audio capture device 20, data sensors 22, or other component to capture raw data from the surrounding environment. This data is then processed through the control device 26, and thereafter, transmitted over the network N using the communications device 28. It is further envisioned that the remote data capture device 12 may be configured or programmed to process the event data 14 to some final or pre-processed form using appropriate software, such as transcription software. This would serve as a full automation of the first “cut” in the transcription process, and would alleviate the need for certain users in the data management trail. Of course, any of the processing steps discussed hereinafter could be implemented on the remote data capture device 12, when in the form of a computer or the like.

The network N may be in the form of a virtual private network, a secured network, an unsecured network, a local area network, a wide area network, or the like. Of course, if privacy is of concern in capturing and transmitting the event data 14, any security features and functions can be used and implemented either at the specified location L (such as on the remote data capture device 12) or at some other position in the network N, such as at the central data receiving interface 16.

As discussed, the system 10 can be used in connection with a variety of locations L and venues. For example, the presently-invented system 10, method, and remote data capture device 12, are particularly useful in connection with meetings or certain legal proceedings. For example, the specified location L may be a courtroom, a hearing room, a deposition room, a meeting room, an arbitration room, a mediation room, or the like.

In another unique aspect of the present invention, the collection and transmission of the event data 14 to the central data receiving interface 16 is implemented in a substantially real-time format. Accordingly, the transmission of the event data 14 by the remote data capture device 12 is substantially at the time of the capture. As discussed hereinafter, this ensures fast and efficient storage and processing of the event data 14 for fast organization and/or distribution.

In a further preferred and non-limiting embodiment of the present invention, the system 10 includes at least one data processing device 30 that is in communication with or is integrated with the central data receiving interface 16. This data processing device 30 is configured or programmed to facilitate the processing of at least a portion of the received event data 14. In one embodiment, the data processing device 30 is configured or programmed to provide the received event data 14 to a user U, and to further receive input from this user U. Such a user U may be a trained or skilled professional capable of transcribing some or all of the raw event data 14 obtained at the specified location L. In this regard, the user U would transcribe the information into another usable format, thereby providing transcription data 32. For example, this transcription data 32 may be textual data that reflects some or all of the event data 14 captured by the remote data capture device 12.

In another preferred and non-limiting embodiment, this user U (or some other remote user U) is capable of communicating, such as through the central data receiving interface 16, back to some computer or other device positioned locally at the specified location L. In this manner, the user U is provided with a communication link between the user U and some other person (associated with a computer) at the live venue. Such communication may take the form of a “chat.” In one embodiment, this chat feature also allows for the cut-and-paste of text into a chat window displayed at a computer at the specified location L, as well as a read-back of the transcription data 32 (or other data processed within the system 10).

In this manner, such a chat feature enables real-time information and data exchange between the user U (located remotely) and a person located at the specified location L. Still further, and within this chat feature, the data processing device 30, or some other computing device, may be configured or programmed to facilitate or automatically transmit certain messages, such as: the event data 14 is being provided too quickly; there is some pause in the proceedings at the specified location L; multiple people are speaking at once at the specified location L, etc. Also, when a read-back is requested by a person at the specified location L, the user U, or, if programmed or configured, the data processing device 30, can facilitate the searching of the transcription data 32, identification of the portion requested, and the cut-and-paste of the data for display to the person at the specified location L. Still further, this “chat” can occur between the user U and multiple people at the specified location L.

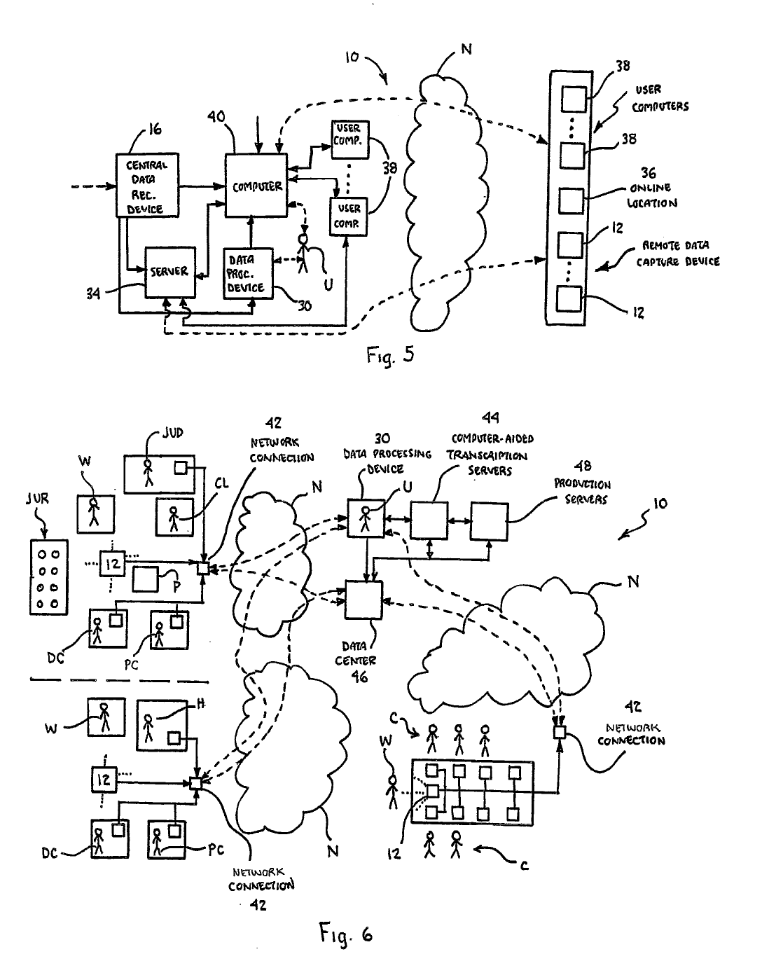

As illustrated in FIG. 4, and in another preferred and non-limiting embodiment, the system 10 may include at least one server 34 that is configured or programmed to receive, store, and/or transmit the event data 14, process data, transcription data 32, testimony data, visual data, oral data, tactile data, chat data, environment data, location data, condition data, or the like. Further, once this information or data is populated on the server 34, such as in a database, it can be subsequently transmitted over the network N to some authorized remote viewer, such as a person located at the specified location L, or some other authorized viewer. For example, some or all of the data captured, processed, or created in the system 10 may be transmitted to an online location 36, such as a website or other secured electronic location, a person's computer 38, some third-party computing system, or the like. Of course, it is further envisioned that this data can be transmitted between the online location 36 and any of the computers 38, again over the network N, and all such transmission may occur in a substantially real-time environment.

In one preferred and non-limiting embodiment, and in a legal context, the system 10 of the present invention can be incorporated with or communicate with the Reporter Electronic Data Interchange (REDI) through the use of appropriate software interfaces. Since the event data 14 and/or the transcription data 32 contains key information on rulings, witnesses, party names, motions, etc., the data 14, 32 (or some other processed data) can be transmitted to or linked with the court's computer system to allow data interchange and exchange with court clerks, probation departments, state prisons, governmental agencies, and the like, for the purpose of creating and accessing minute orders, docket entries, transcripts, case management information, etc. This eliminates the need to directly contact transcription reporters or personnel for information, since it is already captured and stored in a searchable format on the REDI system.

In another preferred and non-limiting embodiment, the system 10 includes a computer 40 (or computing device or system) that is configured or programmed to facilitate the processing of received event data 14, processed or pre-processed data, transcription data 32, testimony data, visual data, oral data, tactile data, chat data, environment data, location data, condition data, or the like. In addition, this computer 40 allows for the organization of the processed data into organized data that may take the form of a report, a transcript, minutes, or the like. This organized data can then be transmitted to the above-discussed online location 36, remote user computers 38 (whether third-party systems or internal systems), as well as to one or more of the remote data capture devices 12. Further, this organized data may be stored locally on the server 34, or on any database associated with the system 10.

It is further envisioned that this computer 40 may obtain a translated data file or some other transcription data 32 and serve as an editing station. In this regard, the transcription data 32 (or some other pre-processed or processed data) may go through a first-pass edit using a proofreading software program. Further, the users U may be remote editors and/or proofreaders that review a transcript (transcription data 32) in real-time, and prepare a rough draft or even final transcripts for delivery and transmission as discussed above. In order to effect this transmission, either the computer 40, the server 34, the data processing device 30, or any other component of the system 10 includes the appropriate components and/or programs to operate within a communications system for facilitating the transmission of data to and from remotely-located users, whether at the specified location L or some other remote location.

In one preferred and non-limiting embodiment, the system 10 allows for the capture and streaming of audio and/or video content from a specified location, such as a courtroom, a deposition suite, a hearing room, an arbitration room, etc., via a secure network connection 42 located at the specified location L. Of course, it is further envisioned that such communications can occur over a dedicated phone line and/or video-conferencing systems for clarity and redundancy purposes. Also, as discussed, any of the data could be captured and stored on the server 34 or any other secure location, again for the use of redundancy and archival purposes.

In addition, and in one embodiment, if the event data 14 is strictly audio or aural data, the system 10 may also include a speaker identification system that is incorporated at the specified location L in order to identify the person that is speaking. For example, unique identification tags may be used in connection with each unique user or person at specified location L, or in connection with each dedicated microphone positioned in or around the specified location L. Of course, the use of security-enabled wireless lavaliere microphones can be utilized, which also prevents removal from the venue or location L.

Various specific implementations and specified locations L are discussed hereinafter. For example, as illustrated in FIG. 6, the specified location L may be a courtroom, such that the people at the specified location L includes a judge JUD, a clerk CL, one or more witnesses W, a jury JUR, one or more defense counsel DC, and one or more plaintiff counsel PC. At this specified location L, it is envisioned that the judge JUD, the defense counsel DC, and the plaintiff counsel PC each have a computer 38 for use in obtaining data within the system 10, as well as interacting with one or more users U to facilitate the chat feature. While the remote data capture device 12 can be a portable unit (as discussed above), it is also envisioned that it can be a permanently installed unit in specific courtrooms or other specified locations L.

In this example, the remote data capture device 12 includes a video capture device 18 and an audio capture device 20, and the event data 14 is sent over a private Internet connection (network connection 42) to the central data receiving interface 16 and/or the data processing device 30. The data processing device 30 receives this event data 14 substantially in real-time and the information is transcribed (either automatically or through the user U) and transmitted to computer-aided transcription servers 44. In addition, this transcription data 32 is translated into a text file that can be sent to a secure online location 36, which may be accessed by the authorized persons in the specified location L, in this case the courtroom, or in some other remote location.

Further, either the central data receiving interface 16 or the data processing device 30 transmits the event data 14 and/or the transcription data 32 to a secure server 34, or in one preferred and non-limiting embodiment, a data center 46. Again, as discussed, remote viewers can use a secure network connection 42 and/or a secure online location 36 to view the real-time transcription data 32, event data 14, or other processed data.

In addition, the event data 14 and/or the transcription data 32 are transmitted to the computer-aided transcription servers 44 in real-time, where the event data 14 and/or the transcription data 32 is translated and sent to some secure online location 36 or other computer for use by the court and/or other recipients of the real-time feed. In addition, this information data is simultaneously sent to production servers 48 for all phases of production and processing.

Finally, in this example, remote users U, e.g., editors and/or proofreaders, access the transcription data 32 (and/or the event data 14) in voice files from the production servers 48, and prepare data files for rough draft or final delivery to the courtroom and other consumers of the transcription service. Further, completed transcripts may be transmitted to the data center 46, which, in turn, delivers them to consumers over the network N.

In a further preferred and non-limiting embodiment, and as also illustrated in FIG. 6, another specified location L in which the presently-invented system 10 can be utilized is at a hearing. In particular, such a hearing would include a hearing officer H (or arbitration/mediation panel), as well as the above-discussed witnesses W, defense counsel DC, and plaintiff counsel PC. In this embodiment, the hearing officer H, defense counsel DC, and plaintiff counsel PC would all have access to the computer 38 that is directly or indirectly in communication with the other portions of the system 10 through the network connection 42. It is further envisioned that the remote data capture device 12 acts as the central node to which each of these computers 38 at the specified location L communicates through to the central data receiving interface 16 or other components of the system 10. This would allow the remote data capture device 12 (preferably in the form of a computer or computing device) to serve as a centralized data collection, processing, transmission, and communication unit.

In yet another embodiment, as further illustrated in FIG. 6, the specified location L may be in the form of a deposition suite. In this preferred and non-limiting embodiment, counsel C would be seated around various positions on the table, typically on opposite sides of the table, with the witness W at the end. In this embodiment, the remote data capture device 12 would be positioned near the end of the table where the witness W is located, and each of the counsel C involved in the proceeding would have a computer 38 functioning in the above-described manner.

Of course, it is further envisioned that the presently-invented system 10 is equally useful in connection with a normal meeting process, where multiple individuals are gathered around a table or in a centralized area at the specific location L, such as a board meeting or the like. As discussed, the remote data capture device 12 would be situated in a central or optimal position for use in effectively and accurately obtaining event data 14. At a meeting facility, it is envisioned that the remote data capture device 12 (or multiple such devices 12) could be permanently installed in the appropriate positions according to the room layout.

In this manner, the present invention provides a remote transcription reporting system 10, method, and remote data capture device 12 that improves or leads to increased efficiency and accuracy, cost effectiveness, and/or improved timeliness. In particular, the system 10, method, and remote capture device 12 provides remote transcription, reporting, and related services, and can be used to capture, deliver, and preserve event data in real-time. Still further, and in some embodiments, the remote data capture device 12 may be portable and wireless, and stationed in specified locations L, such as courtrooms, deposition suites, hearing rooms, arbitrations, and all other venues requiring a visual or textual record that can be moved to and from various venues. This eliminates the need for permanent installation, and further eliminates costs associated with multiple installations.

In addition, the present invention automates the process of obtaining event data and allowing the user U to be in an offsite location engaging in the transcription process, while at the same time allowing interaction between the user U and other remote computers 38, i.e., users of those computers 38. Further, the present invention provides the appropriate functionality to implement the capture, processing, and transmission of data at a specified location L to a remote location, such as a remotely-located server 34, data processing device 30, and/or a central data receiving interface 16.

In addition, and in certain embodiments, the system 10, method, and remote data capture device 12 of the present invention provides offsite storage and processing of event data 14 to provide redundancy in this important process. In this manner, the transcription data 32, including any other associated notes, audio, video, information, etc., can be sent to or stored at any server 34, 44, 46, where they may be translated using computer-aided transcription (CAT) software. The translated data file, i.e., the unedited transcript, may then be sent to a data center 46, where it is available in real-time via a secure website or other online location 36 for viewing and use. Of course, it may also be sent to any remote or third-party computer 38.

Accordingly, the present invention provides a unique and innovative remote transcription reporting system 10, method, and remote data capture device 12 that provides effective, accurate, and timely transcribed data and information for use in a variety of proceedings, meetings, and environments.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A transcription and reporting system, comprising:
at least one remote data capture device positioned in a specified location and configured or programmed to at least one of capture and process event data, and transmit at least a portion of the event data over at least one network; and
at least one central data receiving interface configured or programmed to receive at least a portion of the event data transmitted by the at least one remote data capture device;
wherein at least a portion of the event data is at least one of the following: testimony data, visual data, aural data, tactile data, chat data, environment data, location data, condition data, or any combination thereof.

2. The system of claim 1, wherein the at least one remote data capture device comprises at least one of the following: at least one computer, at least one video capture device, at least one audio capture device, at least one data sensor, or any combination thereof.

3. The system of claim 1, wherein the at least one remote data capture device is a portable unit configured to be positioned in another specified location.

4. The system of claim 1, wherein the at least one network is at least one of the following: a virtual private network, a secured network, an unsecured network, a local area network, a wide area network, or any combination thereof.

5. The system of claim 1, wherein the specified location is at least one of the following: a courtroom, a hearing room, a deposition room, a meeting room, an arbitration room, a mediation room, or any combination thereof.

6. The system of claim 1, wherein the transmission of the at least a portion of the event data by the remote data capture device is substantially at the time of capture of the event data.

7. The system of claim 1, further comprising at least one data processing device in communication with the central data receiving interface and configured or programmed to facilitate the processing of at least a portion of the received event data.

8. The system of claim 7, wherein the at least one data processing device is configured or programmed to provide the received event data to a user and receive input from the user, thereby providing transcription data.

9. The system of claim 8, wherein the transcription data comprises textual data reflecting at least a portion of the event data.

10. The system of claim 1, further comprising at least one server configured to receive, store, and/or transmit at least a portion of the following data: event data, processed data, transcription data, testimony data, visual data, aural data, tactile data, chat data, environment data, location data, condition data, or any combination thereof.

11. The system of claim 10, wherein at least a portion of the data is over the network to at least one authorized remote viewer.

12. The system of claim 1, further comprising at least one computer of the computer system configured or programmed to:
facilitate the processing of at least a portion of at least one of the following:
received event data, processed data, transcription data, testimony data, visual data, aural data, tactile data, chat data, environment data, location data, condition data, or any combination thereof; and
organize at least a portion of the processed data into organized data in the form of at least one of the following: a report, a transcript, minutes, or any combination thereof

13. The system of claim 12, wherein the at least one computer is further configured or programmed to store and/or transmit the organized data to a user.

14. The system of claim 1, further comprising a communication system configured to facilitate communication between at least one user located at the specified location and at least one user located at a remote location.

15. A remote data capture device positioned in a specific location, comprising:
at least one component configured to capture raw data from the surrounding environment;
at least one component configured to process the raw data; and
at least one component configured to transmit at least a portion of the processed data over at least one network.

16. The remote data capture device of claim 15, wherein the at least one component configured to capture raw data comprises at least one of the following: at least one computer, at least one video capture device, at least one audio capture device, at least one data sensor, or any combination thereof

17. The remote data capture device of claim 15, wherein at least one of the components is at least partially positioned within a housing, and wherein the housing is portable and configured to be positioned in another specified location.

18. A computerized transcription and reporting method, comprising:
receiving, over a network, event data from a remote data capture device positioned in a specified location, wherein at least a portion of the event data is at least one of the following: testimony data, visual data, aural data, tactile data, chat data, environment data, location data, condition data, or any combination thereof;
processing at least a portion of the received event data, thereby providing transcription data; and
storing at least a portion of the following data: event data, processed data, transcription data, testimony data, visual data, aural data, tactile data, chat data, environment data, location data, condition data, or any combination thereof

19. The method of claim 18, wherein the specified location is at least one of the following: a courtroom, a hearing room, a deposition room, a meeting room, an arbitration room, a mediation room, or any combination thereof.

20. The method of claim 18, wherein the receipt of at least a portion of the event data captured by the remote capture device is substantially at the time of capture of the event data.

21. The method of claim 18, further comprising transmitting at least a portion of the stored data to an online location on the network accessible by at least one authorized remote viewer.
